(19) United States
(12) Patent Application Publication
(10) Pub. No.: US 2026/0336948 A1
(43) Pub. Date: Oct. 29, 2026

(54) SPREADER SYSTEM

(71) Applicant: TARGAN, Inc., Raleigh, NC (US)

(72) Inventor: Zebulon Rouse, Raleigh, NC (US)

(73) Assignee: TARGAN, Inc., Raleigh, NC (US)

(21) Appl. No.: 19/658,150

(22) Filed: Apr. 24, 2026

Related U.S. Application Data
(60) Provisional application No. 63/795,045, filed on Apr. 25, 2025.

(51) Int. Cl. B65G 47/28; A01K 45/00; B65G 47/82

(52) U.S. Cl. CPC B65G 47/28; A01K 45/005; B65G 47/82; B65G 2201/0202

(57) ABSTRACT

A system for spreading objects (e.g. chicks) includes a moving platform configured to convey the objects in a downstream direction (e.g., conveyor), a movable arm, fingers extending from the movable arm, and an actuator for moving the movable arm. The device is operated using an actuator, swinging the arm (and thus the fingers) in the path of the chicks. As the actuator moves back and forth, the fingers move some of the chicks across the conveyor.

### BACKGROUND

Machines using conveyors currently process animals such as baby chicks. As the chicks move down the conveyor, they have to enter separate lanes for parallel processing thereof. However, these chicks typically bunch up prior to entering the lanes. For example, the chicks may all bunch up in the middle of the conveyor. When the chicks bunch up they could cause a bottleneck at the lanes, get injured, or create higher quantities in different lanes.

However, there is currently no efficient and accurate way of spreading chicks in a processing system that also preserves the health and wellbeing of the chicks.

### SUMMARY

Aspects to at least some embodiments of the present application relate to systems for spreading objects (e.g., baby chicks) being moved through a system.

The system includes a moving platform and arm positioned over the moving platform such that fingers extending from the arm selectively contact some of the chicks and move the contacted chicks laterally relative to a direction of movement of the moving platform while allowing other chicks on the moving platform to pass without contact. The device is operated with using an actuator, swinging “fingers” in the path of the chicks. As the actuator moves back and forth, the fingers move some of the chicks across the conveyor.

In some embodiments, the actuator is configured to reciprocate so as to move the arm back and forth relative to the moving platform, and the fingers are spaced apart such that some chicks are contacted by the fingers while other chicks pass between adjacent fingers.

In one aspect, a system for spreading objects includes: a moving platform configured to convey the objects in a downstream direction; an arm positioned over the moving platform; a plurality of fingers extending from the arm toward the moving platform; and an actuator operatively coupled to the arm and configured to move the arm such that the fingers move in a direction having a transverse component relative to the direction of the moving platform to spread at least some of the objects across the moving platform.

In another aspect, a system for spreading objects includes a movement system configured to facilitate movement of the objects in a downstream direction; an arm positioned proximate to where objects will be moving in the downstream direction; a plurality of fingers extending from the arm. The arm is configured to move so that the fingers are moved in a transverse direction having a directional component transverse to the downstream direction of the movement of the objects to spread at least some of the objects across the moving platform.

In another aspect, a method of spreading objects on a moving platform, includes: conveying the objects on the moving platform in a downstream direction; positioning an arm above the moving platform, the arm including a plurality of fingers extending toward the moving platform; and actuating the arm to move the fingers transversely relative to the downstream direction such that the fingers contact at least some of the objects and move at least some of the objects laterally across the moving platform to spread the objects across a width of the moving platform.

The skilled person will appreciate that except where mutually exclusive, a feature described in relation to any one of the above embodiments may be applied mutatis mutandis to any other embodiment.

### BRIEF DESCRIPTION OF THE DRAWINGS

The disclosure will be described with reference to the accompanying drawings, wherein like numbers reference like elements.

FIGS. 1 and 2 are schematics of a processing system for chicks, according to some embodiments.

FIG. 3 is a perspective view of a spreading portion of the processing system, according to some embodiments.

FIG. 4 is a right perspective view of a spreading portion of the processing system, according to some embodiments.

FIG. 5 is a top view of the spreading portion of FIG. 4, according to some embodiments.

FIG. 6 is a right perspective view of the spreading portion of FIG. 4, according to some embodiments.

### DESCRIPTION OF EXEMPLARY EMBODIMENTS

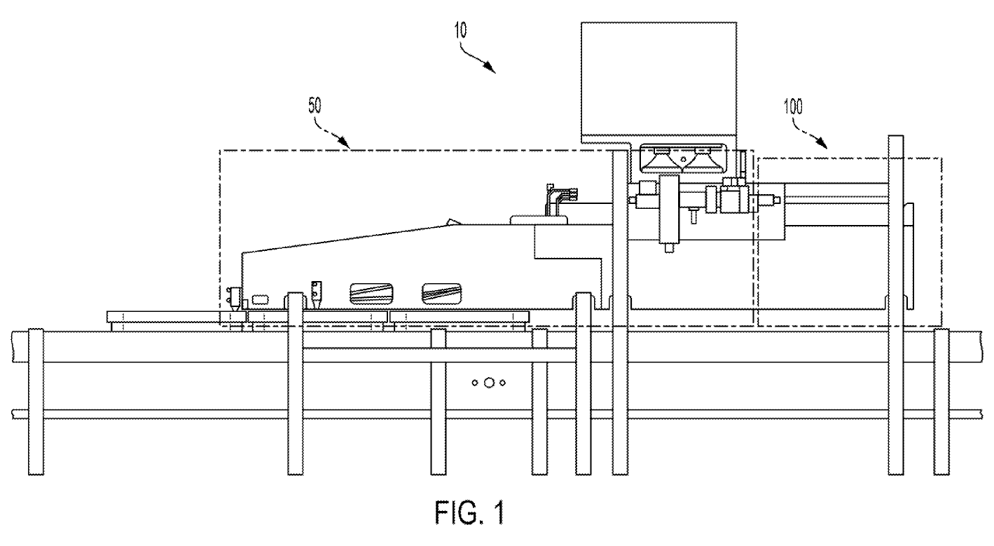

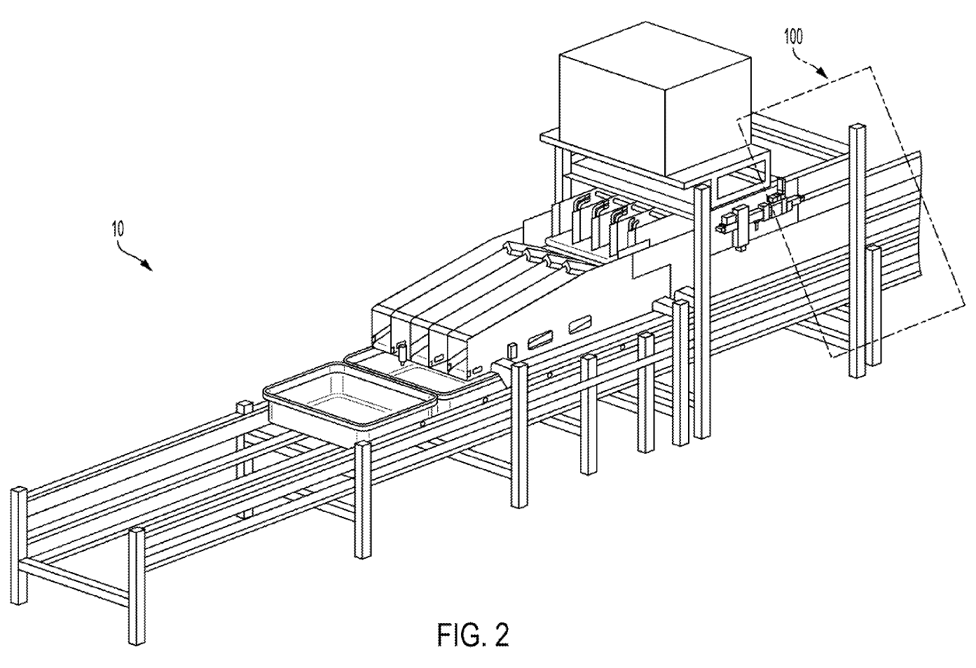

As mentioned above, the present disclosure discloses a processing system that is configured to spread objects, such as animals, prior to delivery of the objects to a downstream process, such as sorting. An exemplary processing system 10 is shown in FIGS. 1-2.

In some embodiments, the processing system 10 is configured to process and sort animals, such as day-old chicks. The animals may be any animals, but the present invention should not be limited to animals or a specific type of animal. The present disclosure uses day-old chicks for purposes of describing the invention, but the invention could be applied to various other living beings other than chicks. Such exemplary embodiments will now be described.

The processing system 10 includes a sorting section to identify and sort the chicks, as shown as reference numeral 50 in FIGS. 1-2. Section 50 of the processing system 10 may include input lanes (where the chicks travel in), output lanes, a moving platform, imaging sensors, one or more air nozzles per lane, and sorted output lanes downstream of the air nozzles.

Upstream of section 50, there is a spreading section 100 (spreader) for spreading the chicks across the moving platform. FIGS. 1-2 show the spreading section 100 relative to the sorting section 50.

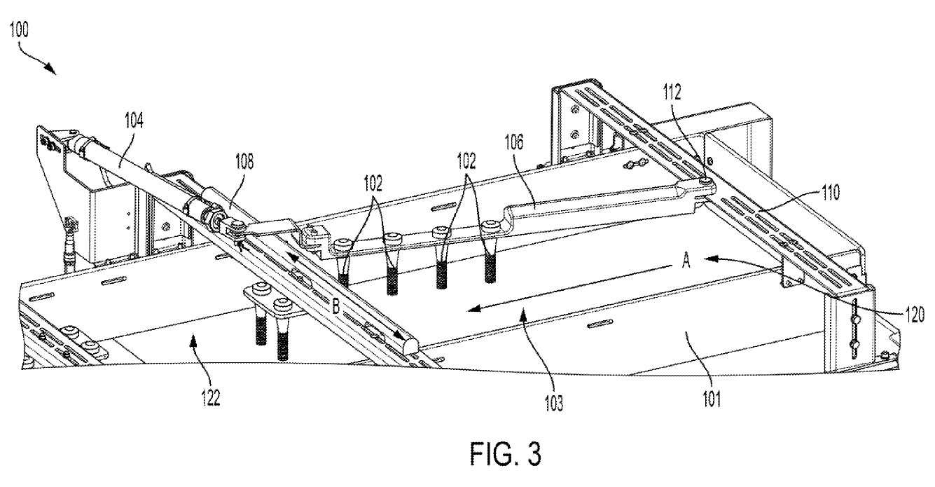

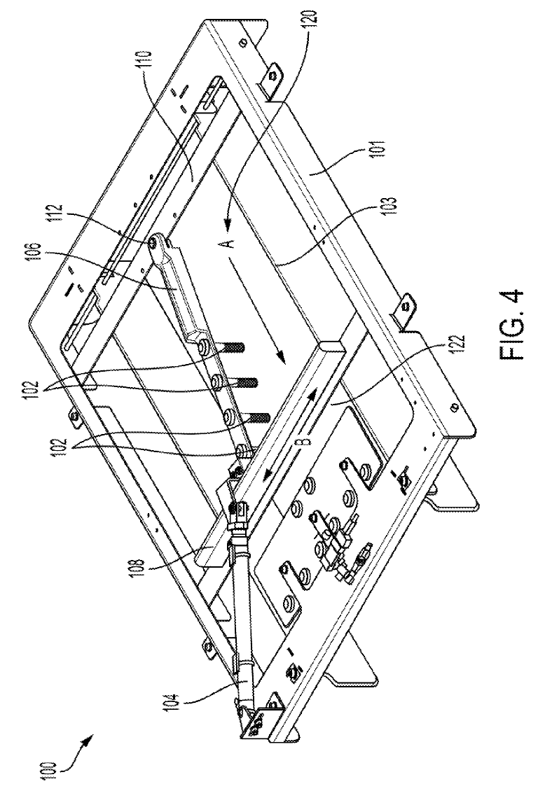

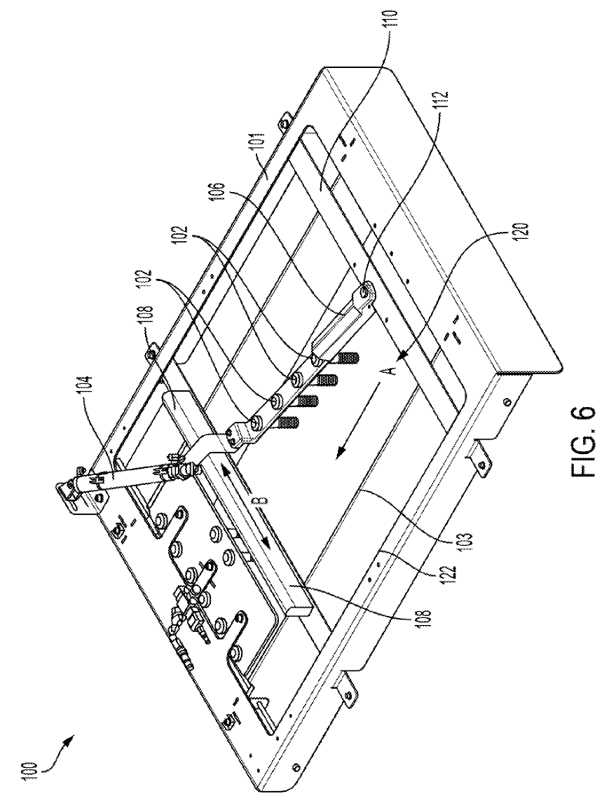

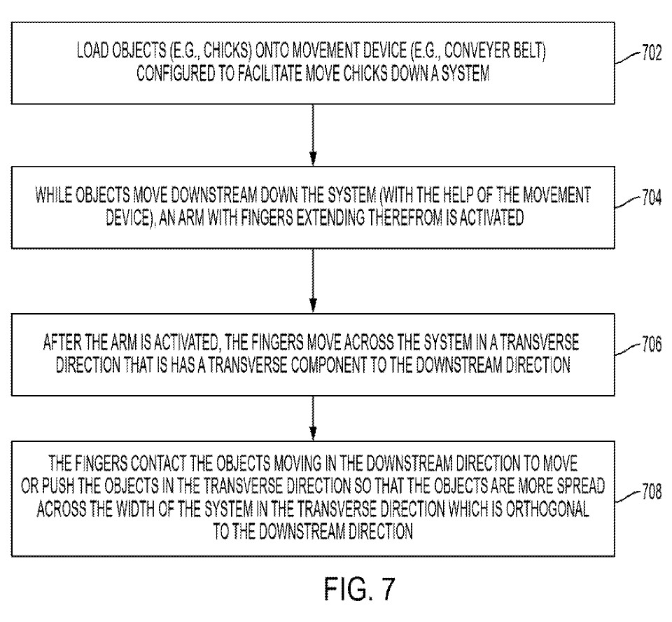

FIG. 3 illustrates one embodiment of the spreading section 100, and FIGS. 4-6 are additional illustrations of the spreading section 100 according to some embodiments. As illustrated in FIGS. 3-6, the spreading section 100 includes a container section 101 which includes the moving platform 103 and walls on the sides of the moving platform 103.

This system is configured for processing a plurality of chicks in a short amount of time where the chicks are delivered to the spreading section 100 of the processing system 10 en masse where the chicks are received on the moving platform 103.

The spreading section 100 includes an arm 106 connected between a first support 110 and a second support 108 so that a first end 150 of the arm 106 is connected to the first support 110 and a second end 151 of the arm 106 is connected to the second support 108. The first support 110, second support 108, and the arm 106 may each be positioned above the container section 101 according to one embodiment. The first end 150 of the arm 106 may be connected to the first support 110 at a pivot point 112, in one embodiment, or the first end 150 of the arm 106 may be connected to the first support 110 in a movable manner so that the first end 150 of the arm 106 is able to move in a first direction (i.e., direction B) which is perpendicular to a second direction (i.e., direction A) of movement of the moving platform. The direction B may be along the longitudinal length of the first support 110. Direction B may be referred to herein as the “transverse direction” while direction A may be referred to as the “downstream direction.”

It is noted that when a targeted direction is referred to, that means the target direction could be the exact referred to direction or at least the targeted direction includes a vector that corresponds to the exact referred to direction. For example, if a direction is referred to as a north direction, a direction of northwest or northeast is included because it has a northern vector component to it.

As shown in FIG. 3 and as mentioned above, the second end 151 of the arm 106 may be connected to the second support 108. The second end 151 of the arm 106 is also connected to an actuator 104 or any other means to allow for movement of the second end 151 of the arm 106 in the first direction (i.e., direction B) perpendicular to the second direction (i.e., direction A) of movement of the moving platform. However, it should be noted that the second end 151 of the arm 106 may be connected only to the actuator 104 and not to the second support 108, to the second support 108 and not the actuator 104, or to both the actuator 104 and the second support 108, according to various embodiments. For ease of illustration, FIGS. 3-6 each illustrates that the second end 151 of the arm is connected to both the actuator 104 and the second support 108. The actuator is configured to move the second end 151 of the arm in the second direction (direction B)using the second support 108 as support and a guide.

While it is shown that the arm 106 pivots so that only the second end 151 of the arm 106 swings in direction B, it should be understood that both the first end 150 and second end 151 of the arm 106 may swing in direction be in a coordinated manner (e.g., continuously together moving side to side generally in the same direction, or when the first end 150 continuously moves in one direction the second end 151 continuously moves in the opposite direction, or some combination therebetween where the first end 150 and second end 151 are offset from each other so that the first end 150 and second end 151 continuously move together in the same direction for a set period of time and then continuously move opposite of each other for another period of time.

The arm 106 includes a series of protrusions 102, also referred to herein as “fingers”. The fingers 102 extend from the arm 106 towards the moving platform 103 so that the fingers 102 can move the objects disposed directly on the moving platform 103. The fingers 102 are spaced from each other in a predetermined manner. For example, the fingers 102 may be spaced from each other so that a single object (e.g., a baby chick) can pass between two of the fingers 102.

The fingers 102 may be flexible but still primarily sturdy and rigid to move the objects in a way that will not damage or hurt the objects. The fingers 102 may thus, be made of rubber or other flexible material in one embodiment. In another embodiment, the fingers 102 may be made of a rigid material such as metal or hard plastic.

The fingers 102 may be removable/replaceable from the arm 106 and are securable to the arm 106 once placed in the arm 106 according to an embodiment. According to another embodiment, the fingers 102 may be integral with the arm 106.

The fingers 102 may extend toward but be spaced from the moving platform 103.

In some embodiments, the fingers 102 may have shapes other than straight rods. For example, the fingers 102 may be curved, tapered, angled, rounded, or paddle-shaped, and may be rigid, semi-rigid, or flexible. The spacing between adjacent fingers 102 may be selected based on the size, type, and throughput of the objects being conveyed, and in some embodiments the spacing may be uniform or non-uniform along the arm 106.

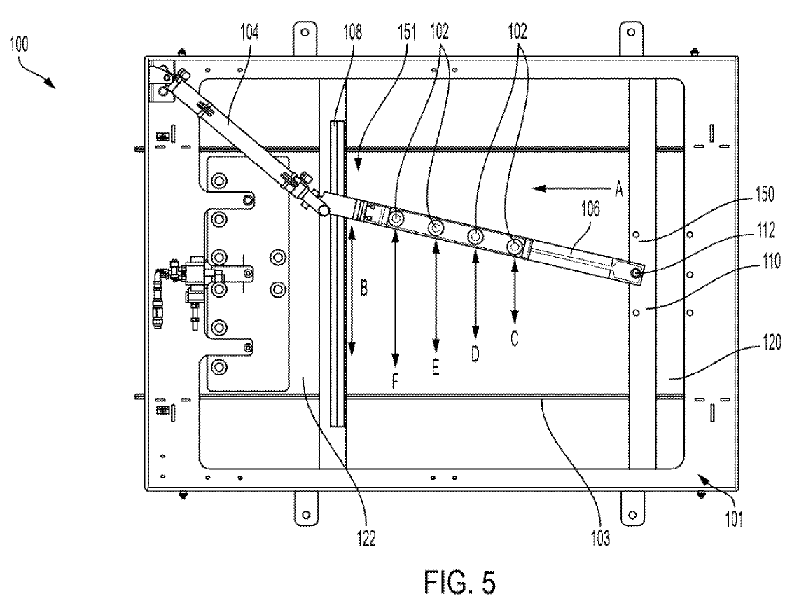

The actuator 104 may be any device configured to apply a force on the second end 151 of the arm 106 to move the arm 106 from opposing sides of the container along direction B in a continuous manner. The actuator 104 is controlled by a computing system that is programed so as to move the actuator 104 and thus the second end 151 of the arm 106 in a predetermined manner. In the exemplary embodiment of FIG. 5, the four fingers 102 then move as shown in directions C, D, E, F, respectively. As shown, some fingers 102 have less displacement, positional movement, and/or velocity than other fingers 102. As such, this allows the chicks to be displaced along the outside and inside of the container 101 and conveyer 103 in an even manner as compared to no spreader at all where the chicks may be concentrated in the center of the conveyer 103.

In another embodiment not specifically illustrated, there may be a second actuator (not shown) for the first end 150 of the arm 106 in a manner similar to the actuator 104 discussed above for the second end 151 of the arm 106. In this manner, having an actuator for each end of the arm 106 allows for both ends of the arm to move simultaneously and therefore the fingers 102 can have varied movement, positioning, and speed relative to the other fingers 102. This is because the second actuator could have a first speed and first movement distance that is different from the second speed and/or second movement distance of the first actuator 104. In this regard, a controller can actively vary the speed and positions of the first and/or second actuators to spread the objects moving on the conveyer based on imaging or other means indicating where a high concentration of chicks are located in order to spread the chicks. This would happen in a high throughput environment where a large amount of chicks are processed quickly as a group coming en masse down the conveyer in direction A.

In such additional embodiment, both ends of the arm are pivotable -- the second end 151 of the arm being pivotable to the actuator 104 and the first end 150 of the arm 106 being pivotable to the first support 110 (or second actuator).

In some embodiments, the actuator 104 may be operated with different frequencies and speeds to achieve a desired spreading effect. A controller may operate the actuator 104 in different operating modes, such as continuous oscillation, intermittent oscillation, oscillation during selected time intervals, or oscillation based on sensed conditions, throughput, object density, or a downstream process requirement.

A method of spreading the chicks will now be described in connection with FIG. 7.

First, in step 702, the chick is loaded onto the conveyor belt in a loading area 120 of the container which is upstream of the fingers 102 (which may be upstream of the first support 110). The chicks may be fed into this loading area 120 using another conveyor belt or disposed in this area in any manner.

Second, in step 704, the chicks are then moved downstream on the moving platform 103, and while this is happening, the arm is activated for movement.

In step 706, while the chicks are moved on the moving platform 103 in direction A, at least one of the ends (e.g., the second end) of the arm 106 is being moved in direction B so that the fingers 102 are moving in a lateral direction perpendicular to (or in a direction having at least a vector in direction B perpendicular to) the direction of movement of the chicks (e.g., direction A).

The speed of the belt is known and the position of the bird on the belt is known. Thus, the speed of the movement of the arm can be changed or coordinated with the speed of the moving platform 103. For example, if the moving platform 103 speed is increased by 10%, the speed of the arm may be increased by 10% as well.

The fingers may be changed depending on the speed of the moving platform, the size/weight/mass of the object/chick, etc. This is because the object/check may take more force to be spread across the moving platform given the initial inertial movement or mass of the object.

In step 708, the fingers make contact with the chicks moving in the downstream direction to move or push the objects in the transverse direction so that the chicks are more spread across the width of the system in the transverse direction which is orthogonal to the downstream direction.

It should be understood that the embodiments are not limited to chicks and thus, the present application can be applicable to any other object, including animals, food, items for manufacture, supplies, or any other object that is processed en masse where there is a high throughput of processing.

It should also be understood that a conveyer belt need not be required and any other device configured to move the objects down the system may be employed, such as an air blowing system, a movement apparatus that pushes or pulls the objects, a slide or other surface where gravity is used to move the objects, or any other way where movement of the objects through the system is facilitated.

It should be understood that the arm may be above, below or to the side the surface that the objects are supported by. As such, the fingers may be extending from the arm in a downward direction, upward direction or a sideways direction.

It should also be noted that this system may be used in a liquid or other environment where the objects may be floating or without full gravitation force. In this regard, the objects could be floating through the system (such as in water), and the arm and fingers be used to spread the objects in the transverse direction relative to the downstream direction.

Various other embodiments are also possible and are within the scope of the present invention provided that the objects are traveling in a system and need to be spread out. In this regard, the present disclosure allows the fingers to effectively spread the objects out relative to each other. Any embodiment that embodies these features are within the scope of the present disclosure.

The terminology used herein is for the purpose of describing particular embodiments only and is not intended to be limiting of embodiments of the invention. As used herein, ‘lateral’, ‘laterally’, ‘transverse’, and similar terms refer to movement having a component across the direction of the moving platform, including movement that is perpendicular to the direction of the moving platform and movement that is oblique relative to the direction of the moving platform. The singular forms "a", "an" and "the" are intended to include the plural forms as well, unless the context clearly indicates otherwise. It will be further understood that the terms "has," "have," "having," "includes," "including," "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The explicit description of the present invention has been presented for purposes of illustration and description, but is not intended to be exhaustive or limited to embodiments of the invention in the form explicitly disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A system for spreading objects, comprising:
a moving platform configured to convey the objects in a downstream direction;
an arm positioned over the moving platform;
a plurality of fingers extending from the arm toward the moving platform; and
an actuator operatively coupled to the arm and configured to move the arm such that the fingers move in a direction having a transverse component relative to the direction of the moving platform to spread at least some of the objects across the moving platform.

2. The system of claim 1, wherein the objects are chicks.

3. The system of claim 1, wherein the moving platform comprises a conveyor belt.

4. The system of claim 1, wherein the arm is pivotably mounted relative to a support structure.

5. The system of claim 4, wherein the actuator is configured to reciprocate to swing the arm back and forth about a pivot point.

6. The system of claim 1, wherein the fingers are spaced apart from one another along a length of the arm such that at least some of the objects pass between adjacent fingers while other objects are contacted by the fingers.

7. The system of claim 1, wherein lower ends of the fingers are spaced above an upper surface of the moving platform by a predetermined distance.

8. The system of claim 1, further comprising side walls adjacent the moving platform, the side walls and the moving platform defining a container section.

9. The system of claim 8, wherein the objects are spread within the container section.

10. A method of spreading objects on a moving platform, comprising:
conveying the objects on the moving platform in a downstream direction;
positioning an arm above the moving platform,
the arm including a plurality of fingers extending toward the moving platform; and
actuating the arm to move the fingers transversely relative to the downstream direction such that the fingers contact at least some of the objects and move at least some of the objects laterally across the moving platform to spread the objects across a width of the moving platform.

11. The method of claim 10, wherein the objects are chicks.

12. The method of claim 10, wherein the moving platform comprises a conveyor belt.

13. The method of claim 10, wherein the arm is pivotably mounted relative to a support structure.

14. The method of claim 13, wherein actuating the arm comprises reciprocating the actuator so as to swing the arm back and forth about a pivot point.

15. The method of claim 10, wherein the fingers are spaced apart from one another along a length of the arm such that at least some of the objects pass between adjacent fingers while other objects are contacted by the fingers.

16. The method of claim 10, wherein lower ends of the fingers are spaced above an upper surface of the moving platform by a predetermined distance.

17. The method of claim 10, further comprising guiding the objects with side walls adjacent the moving platform, the side walls and the moving platform defining a container section.

18. The method of claim 17, further comprising guiding the objects with side walls adjacent the moving platform, the side walls and the moving platform defining the container section.

19. A system for spreading objects, comprising:
a movement system configured to facilitate movement of the objects in a downstream direction;
an arm positioned proximate to where objects will be moving in the downstream direction;
a plurality of fingers extending from the arm; and
wherein the arm is configured to move so that the fingers are moved in a transverse direction having a directional component transverse to the downstream direction of the movement of the objects to spread at least some of the objects across the moving platform.
